(19) United States
(12) Patent Application Publication
(10) Pub. No.: US 2006/0067288 A1
(43) Pub. Date: Mar. 30, 2006

(54) Apparatus and method for dynamically managing sub-channels

(75) Inventors: Seung-seop Shim, Anyang-si (KR); Hyung-jick Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/232,974

(22) Filed: Sep. 23, 2005

(30) Foreign Application Priority Data
Sep. 24, 2004 (KR) 10-2004-0077196

(51) Int. Cl. H04Q 7/24

(52) U.S. Cl. 370/338; 370/464

(57) ABSTRACT

An apparatus and method for dynamically managing sub-channels are provided. The apparatus includes a sub-channel control module, a sub-channel monitoring module, and a scheduling module. The sub-channel control module provides first channel status information on the status of a previous sub-channel for streaming data transmission and requests second channel status information on the status of a current sub-channel. The sub-channel monitoring module provides the second channel status information to the sub-channel control module at the request of the sub-channel control module. The scheduling module receives the first channel status information and the second channel status information from the sub-channel control module and re-assigns sub-channels for streaming data transmission.

### CROSS-REFERENCE TO RELATED APPLICATION

This application claims priority from Korean Patent Application No. 10-2004-0077196 filed on Sep. 24, 2004 in the Korean Intellectual Property Office, the disclosure of which is incorporated herein by reference in its entirety.

### BACKGROUND OF THE INVENTION

1. Field of the Invention

Apparatuses and methods consistent with the present invention relate to dynamically managing sub-channels, and more particularly, to dynamically managing sub-channels in which statuses of sub-channels formed by multi-carrier sub-channel status are recognized and streaming data to be transmitted is assigned to each of the sub-channels in a multi-carrier streaming data transmission system through multiple antennas.

2. Description of the Related Art

In general, in transmitting wireless data, e.g., audio/video (AV) streaming data (hereinafter, referred to as streaming data), the streaming data may not often be transmitted due to fundamental characteristics of a wireless channel as a transmission medium, that is, channel fading caused by use of multiple paths, frequency dependency, and so on.

To minimize occurrence of such problems, a method, which transmits different or the same data simultaneously by installing multiple antennas at a transmitter side and a receiver side, respectively, has been suggested.

Another proposed method to overcome the conventional problems is to transmit data using multiple carriers using a single antenna at a transmitter side and a receiver side, respectively, rather than multiple antennas at both sides, over a wireless channel formed by either antenna. According to this method, data sources, e.g., voice data, character data, and AV data, which constitute streaming data, are assigned to corresponding sub-channels formed by the multiple carriers through a demultiplexer mounted at the transmitter, respectively. The data sources assigned to the respective sub-channels for transmission are combined together through a multiplexer mounted at the receiver. Assigning a data source to a sub-channel is previously determined and fixed at the time of manufacturing the transmitter. However, when a sub-channel that is assigned to a data source, which is quite important or requires fast transmission, is affected by a wireless channel environment, the data source may not be normally transmitted.

A need therefore exists for a way to dynamically assign data sources constituting streaming data to sub-channels so as to be suitable to wireless channel environments.

### SUMMARY OF THE INVENTION

The present invention provides an apparatus and method for dynamically managing sub-channels, in which, at the time of transmission of streaming data, a change in a wireless channel environment is sensed and data sources constituting the streaming data are dynamically assigned to the sub-channels using a result of the sensing.

According to an aspect of the present invention, there is provided an apparatus for dynamically managing sub-channels. The apparatus includes a sub-channel control module, a sub-channel monitoring module, and a scheduling module. The sub-channel control module provides first channel status information on the status of a previous sub-channel for streaming data transmission and requests second channel status information on the status of a current sub-channel. The sub-channel monitoring module provides the second channel status information to the sub-channel control module at the request of the sub-channel control module. The scheduling module receives the first channel status information and the second channel status information from the sub-channel control module and re-assigns sub-channels for streaming data transmission.

According to another aspect of the present invention, there is provided a method for dynamically managing sub-channels. The method includes obtaining first channel status information on the status of a previous sub-channel, obtaining second channel status information on the status of a current sub-channel, and re-assigning sub-channels for streaming data transmission using the first channel status information and the second channel status information.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of an apparatus for dynamically managing sub-channels according to an exemplary embodiment of the present invention;

FIG. 2 is a flowchart illustrating a method for dynamically managing sub-channels according to an exemplary embodiment of the present invention;

FIG. 3 illustrates an example of a data structure of channel status information according to an exemplary embodiment of the present invention;

FIG. 4 is a block diagram of an apparatus for dynamically managing sub-channels according to another exemplary embodiment of the present invention; and

FIG. 5 is flowchart illustrating a process of receiving streaming data according to an exemplary embodiment of the present invention.

### DETAILED DESCRIPTION OF THE EXEMPLARY EMBODIMENTS

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Exemplary embodiments of present invention are described hereinafter with reference to flowchart illustrations of methods according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which comprises one or more executable instructions for implementing the specified logical function(s). It should also be noted that in some alternative implementations, the functions noted in the blocks may occur out of the order shown. For example, two blocks shown in succession may in fact be executed substantially concurrently or the blocks may sometimes be executed in the reverse order, depending upon the functionality involved.

Hereinafter, an apparatus and method for dynamically managing sub-channels according to exemplary embodiments of the present invention will be described with reference to the accompanying drawings.

An apparatus for dynamically managing sub-channels according to an exemplary embodiment of the present invention receives and stores streaming data from an external device connected through a wired or a wireless medium or holds streaming data using a storage medium. The apparatus also transmits streaming data to a display device or a device for reproducing streaming data through a wireless medium in accordance with protocol for wireless transmission of streaming data. Preferably, the wireless protocol may be composed of an application layer, a medium access control (MAC) layer, and a physical (PHY) layer for streaming data transmission.

The apparatus also transmits data sources constituting streaming data to the display device or the streaming data reproducing device using multi-carriers through a single antenna.

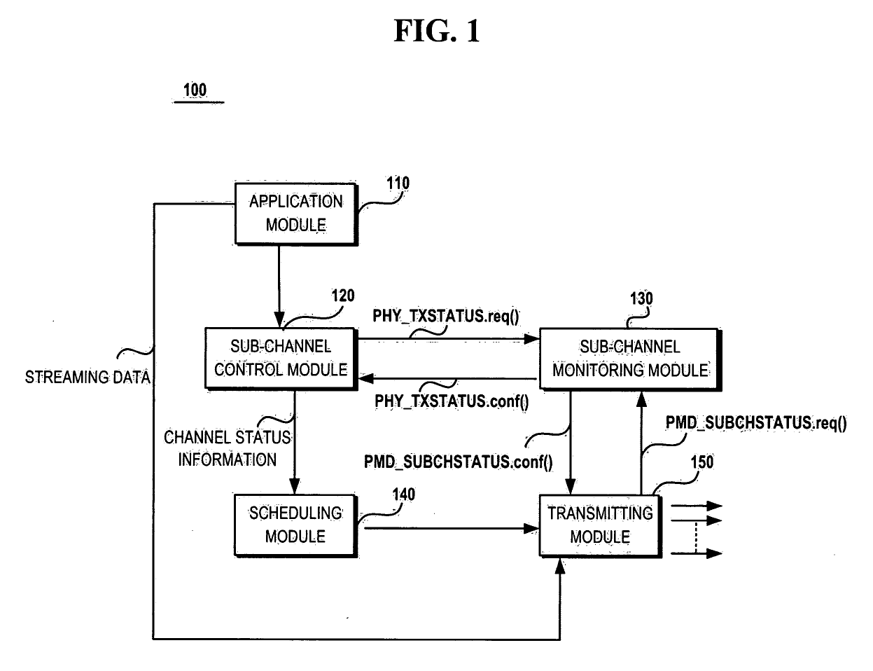

FIG. 1 is a block diagram of an apparatus for dynamically managing sub-channels according to an exemplary embodiment of the present invention.

Referring to FIG. 1, an apparatus 100 for dynamically managing sub-channels includes an application module 110, a sub-channel control module 120, a sub-channel monitoring module 130, a scheduling module 140, and a transmitting module 150.

The application module 110 is an application program for transmitting streaming data that is received from outside the apparatus 100 or is previously stored in the apparatus 100 to a device for executing or reproducing streaming data.

The sub-channel control module 120 provides information on the status of a previous sub-channel (hereinafter, referred to as first channel status information) and requests information regarding the status of a current sub-channel (hereinafter, referred to as second channel status information) for streaming data transmission.

The sub-channel monitoring module 130 obtains the second channel status information and provides the same to the sub-channel control module 120.

The scheduling module 140 receives the first channel status information and the second channel status information from the sub-channel control module 120 and re-assigns a sub-channel for streaming data transmission using the received first channel status information and second channel status information.

The transmitting module 150 transmits the streaming data to the device for executing or reproducing streaming data based on information regarding the re-assigned sub-channel.

The term “module,” as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

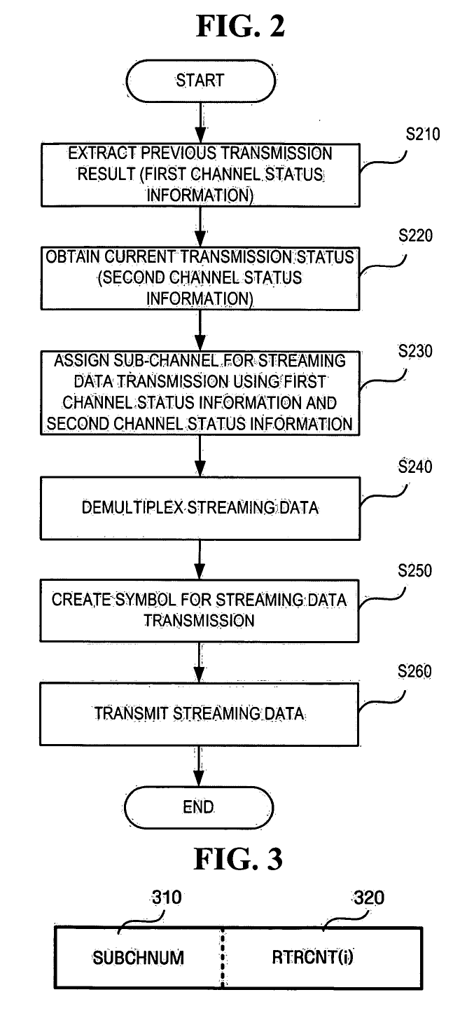

Hereinafter, an operation of the apparatus 100 will be described in detail with reference to FIGS. 2 and 3. FIG. 2 is a flowchart illustrating a method for dynamically managing sub-channels according to an exemplary embodiment of the present invention. FIG. 3 illustrates an example of a data structure of channel status information according to an exemplary embodiment of the present invention.

Once the application module 110 generates an event for streaming data transmission and the sub-channel control module 120 senses the generation of the event, the sub-channel control module 120 extracts information regarding a transmission result of streaming data that is previously transmitted by the transmitting module 150, i.e., the first channel status information, from a temporary storage region in the apparatus 100, in step S210. At this time, the first channel status information has a data structure as shown in FIG. 3, in which SUBCHNUM field 310 includes identification information of each sub-channel and RTRCNT(i) field 320 includes information on the number of re-transmission of streaming data over an i^{th} sub-channel. Preferably, the identification information includes a serial number assigned to each sub-channel.

The sub-channel control module 120 transmits a PHY_TXSTATUS.requ( ) message that requests the second channel status information to the sub-channel monitoring module 130 to obtain information concerning the current transmission status of streaming data. The sub-channel monitoring module 130 then transmits a PMD_SUBCHSTATUS.req( ) message that requests information on the current transmission status of streaming data transmitted over each sub-channel to the transmitting module 150.

The transmitting module 150 transmits a PMD_SUBCHASTATUS.conf( ) message including the current number of transmission of data sources constituting streaming data over each sub-channel to the sub-channel monitoring module 130.

The sub-channel monitoring module 130 extracts information on the current number of transmission from the received PMD_SUBCHASTATUS.conf( ) message, creates the data structure as shown in FIG. 3 using the extracted information, and transmits a PHY_TXSTATUS.conf( ) message including the created data structure to the sub-channel control module 120.

According to another exemplary embodiment of the present invention, the sub-channel monitoring module 130 may transmit the PHY_TXSTATUS.conf( ) message including the information on the current number of transmission to the sub-channel control module 120, and the sub-control module 120 may create the data structure as shown in FIG. 3 using the information on the current number of transmission included in the PHY_TXSTATUS.conf( ) message.

In this way, the sub-channel control module 120 obtains the current transmission status of streaming data, i.e., the second channel status information in step S220.

The sub-channel control module 120 transmits the first channel status information and the second channel status information to the scheduling module 140.

The scheduling module 140 extracts information on the number of re-transmission of data sources over each sub-channel from the first channel status information and the second channel status information and applies a weight to each sub-channel according to the number of re-transmission. For example, as the number of re-transmission is smaller, a larger weight is applied to a corresponding sub-channel, and weights of the same sub-channel included in the first channel status information and the second channel status information are summed. At this time, since transmission of data sources is efficiently performed over a sub-channel having a larger sum of weights, a sub-channel for streaming data transmission is re-assigned according to its weight in step S230.

The transmitting module 150 receives streaming data to be transmitted from the application module 110 and performs demultiplexing, i.e., assigns data sources constituting the received streaming data to sub-channels that are re-assigned by the scheduling module 140, in step S240. The transmitting module 150 creates a symbol for streaming data transmission using a predetermined method in step S250 and transmits the created symbol in step S260.

In order to perform these operations, it is preferable that the sub-channel control module 120 and the scheduling module 140 operate in a MAC layer of protocol for wireless communication.

In addition, it is preferable that the sub-channel monitoring module 130 and the transmitting module 150 operate in a PHY layer of protocol for wireless communication.

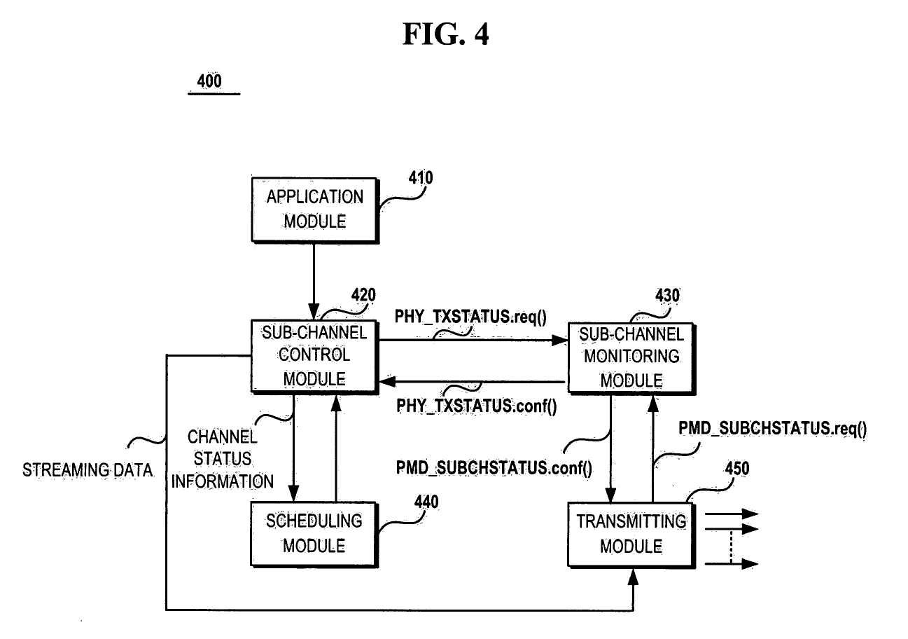

FIG. 4 is a block diagram of an apparatus for dynamically managing sub-channels according to another exemplary embodiment of the present invention.

Like in FIG. 1, a sub-channel control module 420 obtains first channel status information and second channel status information and transmits the obtained first channel status information and second channel status information to a scheduling module 440, and the scheduling module 440 assigns a sub-channel for streaming data transmission using the received first channel status information and second channel status information.

However, the scheduling module 440 transmits a result of sub-channel re-assignment to the sub-channel control module 420 rather than to a transmitting module 450.

The sub-channel control module 420 transmits streaming data received from an application module 410 and information on sub-channel re-assignment received from the scheduling module 440 to the transmitting module 450. The transmitting module 450 demultiplexes data sources constituting streaming data to each re-assigned sub-channel and performs steps S250 and S260.

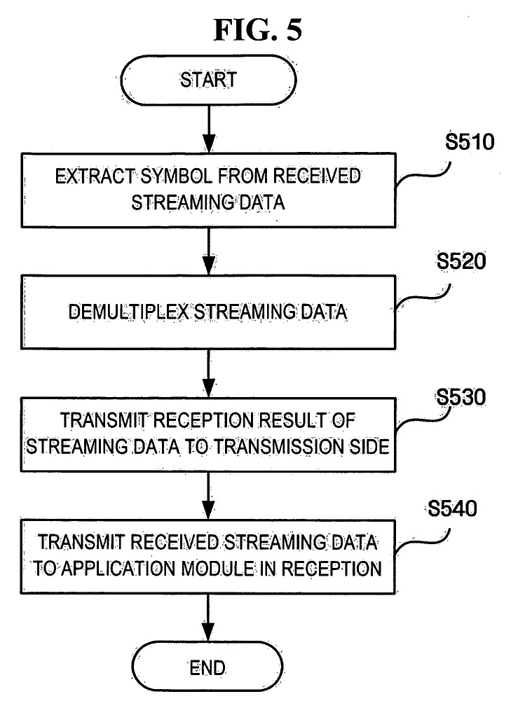

FIG. 5 is flowchart illustrating a process of receiving streaming data according to an exemplary embodiment of the present invention.

Once a device for receiving or reproducing streaming data receives streaming data from an apparatus including blocks shown in FIG. 1 or FIG. 4, a data symbol is extracted from data sources transmitted over each sub-channel in step S510, and extracted data symbols with respect to sub-channels are added together and multiplexing is performed in step S520.

A reception result of streaming data is transmitted to a transmission side in step S530. Such transmission is required to request the transmission side to re-transmit data sources that are received abnormally or are not received. The re-transmission may be performed using a conventional re-transmission method in wireless communication. According to another exemplary embodiment of the present invention, step S530 may be performed prior to step S520.

The received streaming data is transmitted to an application module in a reception side and reproduction of the streaming data is performed in step S540.

An example of the apparatus including blocks shown in FIG. 1 or FIG. 4 may be a set-top box (STB) in home or a streaming data server. The device for receiving or reproducing streaming data which performs the process of FIG. 5 may be a display device such as a digital television or a wireless terminal device that reproduces streaming data.

According to exemplary embodiments of the present invention, in a system that transmits streaming data using multi-carriers over a channel, data sources constituting streaming data to be transmitted are re-assigned according to the status of each sub-channel formed by each of the multi-carriers, thereby improving efficiency in transmission of wireless data according to a change in a wireless environment.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for dynamically managing sub-channels, the apparatus comprising:
a sub-channel control module which provides first channel status information on a status of a previous sub-channel for streaming data transmission and requests second channel status information on a status of a current sub-channel;
a sub-channel monitoring module which provides the second channel status information to the sub-channel control module at a request of the sub-channel control module; and
a scheduling module which receives the first channel status information and the second channel status information from the sub-channel control module and re-assigns sub-channels for streaming data transmission.

2. The apparatus of claim 1, wherein the first channel status information and the second channel status information include identification information of each of the sub-channels and information on a number of re-transmission of the streaming data over each of the sub-channels identified by the identification information.

3. The apparatus of claim 2, wherein the identification information includes a serial number assigned to each of the sub-channels.

4. The apparatus of claim 2, wherein the scheduling module assigns a weight that varies with the number of re-transmission to the number of re-transmission included in the first channel status information and the second channel status information and re-assigns the sub-channels for streaming data transmission according to the assigned weight.

5. The apparatus of claim 1, further comprising:
an application module which provides the streaming data and informs the sub-channel control module of a start of streaming data transmission; and
a transmitting module which receives the streaming data from the application module and transmits the received streaming data over the sub-channels re-assigned by the scheduling module.

6. The apparatus of claim 1, further comprising:
an application module which provides the streaming data to the sub-channel control module and informs the sub-channel control module of a start of streaming data transmission; and
a transmitting module which receives the streaming data from the sub-channel control module and transmits the received streaming data over the sub-channels re-assigned by the scheduling module.

7. The apparatus of claim 1, wherein the sub-channel control module operates in a medium access control (MAC) layer.

8. The apparatus of claim 1, wherein the sub-channel monitoring module operates in a physical layer.

9. A method for dynamically managing sub-channels, the method comprising:
obtaining first channel status information on a status of a previous sub-channel;
obtaining second channel status information on a status of a current sub-channel; and
re-assigning sub-channels for streaming data transmission using the first channel status information and the second channel status information.

10. The method of claim 9, wherein the first channel status information and the second channel status information include identification information of each of the sub-channels and information on a number of re-transmission of the streaming data over each of the sub-channels identified by the identification information.

11. The method of claim 10, wherein the identification information includes a serial number assigned to each of the sub-channels.

12. The method of claim 10, wherein the re-assigning of the sub-channels comprises assigning a weight that varies with the number of re-transmission to the number of re-transmission included in the first channel status information and the second channel status information and re-assigning the sub-channels for streaming data transmission according to the assigned weight.

13. The method of claim 9, wherein in the obtaining of the first channel status information, operations are performed in a medium access control (MAC) layer.

14. The method of claim 9, wherein in the obtaining of the second channel status information, operations are performed in a physical layer.
